(19) United States
(12) Patent Application Publication
(10) Pub. No.: US 2025/0080965 A1
(43) Pub. Date: Mar. 6, 2025

(54) Electronic Devices with Alert Geofencing

(71) Applicant: Apple Inc., Cupertino, CA (US)

(72) Inventors: Utkarsh Kumar, San Jose, CA (US); Samuel J. Miller, San Jose, CA (US)

(21) Appl. No.: 18/773,078

(22) Filed: Jul. 15, 2024

Related U.S. Application Data
(60) Provisional application No. 63/580,333, filed on Sep. 1, 2023.

(51) Int. Cl. H04W 4/90; H04W 4/021

(52) U.S. Cl. CPC H04W 4/90; H04W 4/021

(57) ABSTRACT

A communications system may include a user equipment (UE) device, a cellular network, a core network, and an emergency alert originator that broadcasts an emergency alert. The core network transmits a message to the UE that identifies a first region associated with the alert. The cellular network transmits a message to the UE that identifies a second region associated with the alert. The UE generates an expanded region as a hull around the first region and monitors its location relative to the hull. The UE displays a message body of the alert if/when the UE is within the hull and the first region is sufficiently similar to the second region. This may allow the UE to inform a user of the alert as rapidly as possible, regardless of how the cellular network and/or the core network interpret the emergency alert broadcast by the emergency alert originator.

This application claims the benefit of U.S. Provisional Patent Application No. 63/580,333, filed Sep. 1, 2023, which is hereby incorporated by reference herein in its entirety.

### FIELD

This disclosure relates generally to wireless communications, including wireless communications performed by user equipment devices.

### BACKGROUND

Communications systems can include user equipment devices that convey wireless data with cellular networks. The wireless data can include emergency alert messages that are transmitted by a source for broadcast to all user equipment devices within a specific geographic area.

In practice, it can be challenging to ensure that emergency alert messages are broadcast within the correct geographic area, particularly when different cellular networks operate within the same geographic area or across different geographic areas. In addition, it is important for a user equipment device to be able to display emergency alert messages relevant to its location as promptly as possible.

### SUMMARY

A communications system may include a user equipment (UE) device, a cellular network, a core network, and an emergency alert originator. The emergency alert originator broadcasts a wireless emergency alert message received by the cellular network and the core network. The emergency alert message may identify a first geographic region.

The core network generates a network alert message based on the emergency alert message. The network alert message identifies a second geographic region based on the first geographic region (e.g., county codes, etc.). The core network transmits the network alert message to the UE device over the hypertext transfer protocol (HTTP). The cellular network generates a carrier alert message based on the emergency alert message. The carrier alert message identifies a third geographic region based on the first geographic region (e.g., county codes, etc.). The cellular network transmits the carrier alert message to the UE device using a base station.

The UE device may perform an N-test and an S-test on the second and third geographic regions. The UE device may display the message body of the emergency alert message if/when the S-test is satisfied. In performing the N-test, the UE device generates an expanded geographic region from a hull around polygons having an augmented radius. The augmented radius may be calculated by convoluting normalized custom parameters (e.g., user speed, severity level, etc.). Each of the polygons is formed around a respective vertex of the second geographic region. The UE device may then monitor its location relative to the second geographic region if the N-test is satisfied. The UE device satisfies the N-test if the UE device is located within the hull (e.g., the expanded geographic region). In performing the S-test, the UE device compares the second geographic region to the third geographic region. The UE device satisfies the S-test if/when the second and third geographic regions are sufficiently similar. In this way, the UE device may dynamically and flexibly inform its user of the emergency alert as rapidly as possible regardless of changes to the first geographic region that are performed by the cellular network in generating the carrier alert message and/or by the core network in generating the network alert message. Additionally or alternatively, the UE device may display the alert message upon receipt via HTTP if faster. If the S-test is satisfied after receiving the carrier alert from the cellular network, the UE device may effectively extend the broadcasted area based on the third geographic region and alert potentially new UE devices that do not overlap the second geographic region.

An aspect of the disclosure provides a method of operating an electronic device. The method can include receiving, using a receiver, a message from a core network, the message identifying a first geographic region associated with an emergency alert broadcast by an emergency alert originator. The method can include displaying, using a display, a message body of the emergency alert when the electronic device is located in a second geographic region, the second geographic region being larger than the first geographic region and including the first geographic region.

An aspect of the disclosure provides a method of operating an electronic device. The method can include receiving, using a receiver, a first message from a core network, the first message identifying a first geographic region associated with an emergency alert broadcast by an emergency alert originator. The method can include receiving, using one or more antennas, a second message from a cellular network different from the core network, the second message identifying a second geographic region associated with the emergency alert. The method can include displaying, using a display, a message body of the emergency alert when the first geographic region and the second geographic region exhibit more than a threshold level of similarity.

An aspect of the disclosure provides an electronic device. The electronic device can include a receiver configured to receive, from a core network, a first message identifying a first geographic area associated with an emergency alert broadcast by an emergency alert originator. The electronic device can include one or more antennas configured to receive, from a cellular network different from the core network, a second message identifying a second geographic area associated with the emergency alert. The electronic device can include a display configured to display, based on the geographic area, a location of the electronic device, and a velocity of the electronic device, a message body of the emergency alert after receipt of the second message by the one or more antennas.

### BRIEF DESCRIPTION OF THE DRAWINGS

FIG. 1 is a diagram of an illustrative communications system having a user equipment device, a cellular network, a core network, and an emergency alert originator that broadcasts emergency alert messages in accordance with some embodiments.

FIG. 2 is a schematic block diagram of an illustrative user equipment device in accordance with some embodiments.

FIG. 3 is a flow chart of illustrative operations performed by a user equipment device to display an emergency alert message from an emergency alert originator in accordance with some embodiments.

FIG. 4 is a flow chart of illustrative operations involved in using a user equipment device to generate an expanded alert region for determining whether to display an emergency alert message in accordance with some embodiments.

FIG. 5 is a diagram showing how an illustrative user equipment device may generate an expanded alert region around a network alert region for use in determining whether to display an emergency alert message in accordance with some embodiments.

FIG. 6 is a flow chart of illustrative operations involved in using a user equipment device to compare a network alert region to a carrier alert region for determining whether to display an emergency alert message in accordance with some embodiments.

FIG. 7 is a diagram showing how an illustrative network alert region may differ from a carrier alert region in accordance with some embodiments.

FIG. 8 is a diagram showing one example of how an illustrative graphical user interface of a user equipment device may display an emergency alert message from an emergency alert originator in accordance with some embodiments.

### DETAILED DESCRIPTION

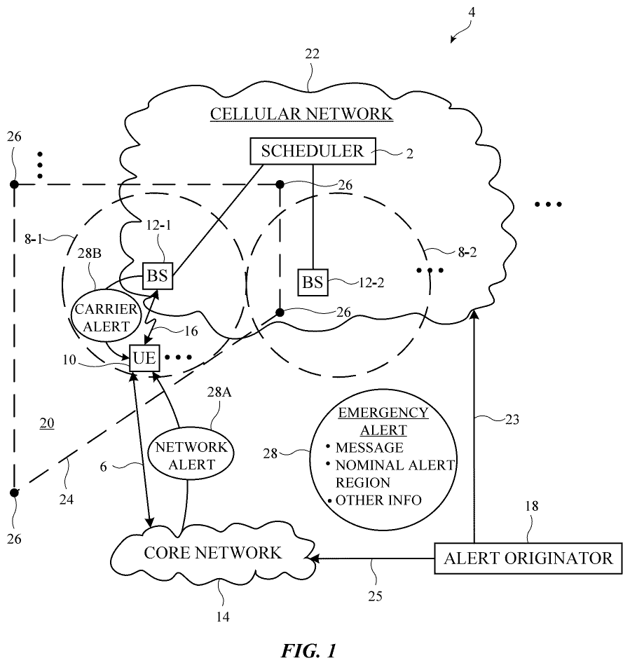

FIG. 1 is a diagram of an illustrative communications system 4. Communications system 4 (sometimes referred to herein as communications network 4, network 4, or system 4) includes a user equipment (UE) device 10 that communicates with a wireless network such as cellular network 22 (e.g., a cellular telephone network). Communications system 4 also includes a core network 14.

In general, communications system 4 (e.g., cellular network 22, core network 14, other network portions of system 4, etc.) may include any desired number of network nodes, terminals, and/or end hosts that are communicably coupled together using communications paths that include wired and/or wireless links. The wired links may include cables (e.g., ethernet cables, optical fibers or other optical cables that convey signals using light, telephone cables, radio-frequency cables such as coaxial cables or other transmission lines, etc.). The wireless links may include short range wireless communications links that operate over a range of inches, feet, or tens of feet, medium range wireless communications links that operate over a range of hundreds of feet, thousands of feet, miles, or tens of miles, and/or long range wireless communications links that operate over a range of hundreds or thousands of miles.

The nodes of system 4 (e.g., cellular network 22, core network 14, other network portions of system 4, etc.) may be organized into one or more relay networks, mesh networks, local area networks (LANs), wireless local area networks (WLANs), ring networks (e.g., optical rings), cloud networks, virtual/logical networks, the Internet (e.g., may be communicably coupled to each other over the Internet), combinations of these, and/or using any other desired network topologies. The network nodes, terminals, and/or end hosts of system 4 (e.g., cellular network 22, core network 14, other network portions of system 4, etc.) may include network switches, network routers, optical add-drop multiplexers, other multiplexers, repeaters, modems, portals, gateways, servers, network cards (line cards), wireless access points, wireless base stations, and/or any other desired network components. The network nodes may include physical components such as electronic devices, servers, computers, network racks, line cards, user equipment, etc., and/or may include virtual components that are logically defined in software and that are distributed across (over) two or more underlying physical devices (e.g., in a cloud network configuration).

Cellular network 22 may include one or more wireless base stations 12 such as at least a first base station (BS) 12-1 (e.g., a gNB) and a second base station 12-2. Each base station 12 in cellular network 22 may include one or more antennas. An antenna may include two or more antenna elements such as antenna elements in a phased antenna array. The one or more antennas may provide wireless coverage for UE devices located within a cell 8 (e.g., the coverage area or service area of the base station). Each base station 12 may have a respective cell 8 in cellular network 22 that covers a corresponding geographic area and each base station 12 may communicate with UE devices located within its cell. For example, base station 12-1 may have a first cell 8-1 whereas base station 12-2 has a second cell 8-2. Cells 8-1 and 8-2 may be completely non-overlapping or may be at least partially overlapping.

Each cell 8 of cellular network 22 may have any desired shape (e.g., a circular shape, a hexagonal shape, etc.) and may cover any desired area. In general, the size of a cell may correspond to the maximum transmit power level of its base station 12 and the over-the-air attenuation characteristics for radio-frequency signals conveyed by that base station 12, for example. The cells of cellular network 22 may be distributed over one or more geographic regions, areas, or locations such as one or more buildings, campuses, cities, counties, provinces, states, countries, or continents.

UE device 10 may wirelessly communicate with a given base station 12 using a wireless communications link. For example, when located within cell 8-1, UE device 10 may convey radio-frequency signals 16 with base station 12-1 to support the wireless communications link. Radio-frequency signals 16 may be conveyed in an uplink (UL) direction from UE device 10 to base station 12-1 and/or in a downlink (DL) direction from base station 12-1 to UE device 10. Radio-frequency signals 16 conveyed in the DL direction are sometimes referred to herein as DL signals. Radio-frequency signals 16 conveyed in the UL direction are sometimes referred to herein as UL signals. UE device 10 may wirelessly communicate with base station 12-1 without passing communications through any other intervening network nodes in system 4 (e.g., UE device 10 may communicate directly with base station 12-1 over-the-air). If desired, UE device 10 may concurrently communicate with multiple base stations 12 of cellular network 22 (e.g., under a carrier aggregation (CA) scheme).

System 4 may include multiple cellular networks 22, a single of which is illustrated in FIG. 1 for the sake of simplicity. Each cellular network 22 may include a different respective set of base stations 12. The cells of different cellular networks 22 may be non-overlapping or may at least partially overlap with each other (e.g., in regions that have coverage from multiple cellular carriers). The cells of different cellular networks may have different locations, shapes, and/or sizes. Each cellular network 22 is operated, controlled, serviced, and/or administered by a corresponding cellular network operator (sometimes also referred to herein as a cellular service provider, a cellular carrier, or simply as a carrier). Each UE device of a given cellular network 22 (e.g., UE devices registered with the cellular network) may, for example, include a subscriber identity module (SIM) associated with that cellular network 22 and/or the carrier of that cellular network 22. Cellular network 22 and the corresponding cellular network operator may sometimes be referred to herein collectively as “the network.”

The cellular network operator may use one or more schedulers such as scheduler 2 to generate, store, maintain, update, and/or implement one or more communications schedules for the UE devices that communicate with the base stations of cellular network 22 (e.g., UE devices registered with cellular network 22). The communications schedule identifies the communications resources (e.g., frequency resources, timing resources, radio access technology (RAT) resources, data modulation/encoding resources, etc.) used to convey wireless data to and/or from each of the UE devices of cellular network 22 (e.g., in a manner that balances traffic loads across the resources of cellular network 22 while minimizing interference between the UE devices). Scheduler 2 may be stored on storage circuitry on one or more base stations 12 and/or other nodes of cellular network 22. Scheduler 2 may be implemented/executed using one or more processors located on one or more base stations 12, on one or more other nodes of cellular network 22, and/or distributed across two or more nodes of cellular network 22.

UE device 10 may convey wireless data with another node of system 4 via base station 12. For example, UE device 10 may transmit wireless data (e.g., UL data) to base station 12-1 (using radio-frequency signals 16) for forwarding to an end host of system 4 (e.g., another UE device, a destination device or server, a destination cloud region, etc.). Additionally or alternatively, base station 12 may receive wireless data from an end host of system 4 (e.g., another UE device, a source device or server, a source cloud region, a content delivery network (CDN), an emergency alert originator, etc.) for forwarding to UE device 10 (e.g., as DL data in radio-frequency signals 16).

The wireless data conveyed to and/or from UE device 10 by cellular network 22 may include any desired wireless data (e.g., application data, streaming audio data, streaming video data, email messages, text messages, notifications, emergency messages, internet data, image data, operating system data, cloud computing data, cloud synchronization data, one or more files, etc.). The wireless data may also include some or all of an emergency alert message transmitted by an emergency alert originator such as emergency alert originator 18.

Emergency alert originator 18 may include one or more nodes of system 4 such as end hosts, servers, a cloud region, etc. Emergency alert originator 18 may generate and broadcast emergency alerts such as emergency alert message 28 for distribution, via cellular network 22 and/or other wired and/or wireless networks of system 4, to UE devices in geographic areas relevant to the emergency alerts. Emergency alert originator 18 is sometimes also referred to herein as alert originator 18, emergency message originator (source) 18, emergency broadcast originator (source) 18, emergency message broadcaster 18, or emergency alert broadcaster 18. Emergency alert message 28 is sometimes also referred to herein as emergency message 28, emergency alert 28, emergency broadcast message 28, emergency broadcast alert 28, or simply as alert 28.

Emergency alert originator 18 may be owned, operated, and/or managed by an emergency alert service provider, a governmental entity, a regulatory entity, a law enforcement agency, a public service entity (e.g., a fire department or system), a non-profit organization, a meteorological entity, an Earthquake monitoring system, a hurricane monitoring system, a tornado monitoring system, a weather monitoring system, a wildfire monitoring system, an international organization, or another entity. Emergency alert originator 18 may, for example, include one or more devices or servers of the Integrated Public Alert and Warning System (IPAWS), the Emergency Alert System (EAS), the ShakeAlert system, or the Wireless Emergency Alerts (WEA) system (e.g., when system 4 is located at least partially in the United States), the National Public Alerting System (NPAS) (e.g., when system 4 is located at least partially in Canada), the Earthquake Early Warning (EEW) system or J-Alert system (e.g., when system 4 is located at least partially in Japan), the National Severe Weather Warning Service (NSWWS) (e.g., when system 4 is located at least partially in the United Kingdom), the Mexican Seismic Alert System (e.g., when system 4 is located at least partially in Mexico), the EU-Alert system (e.g., when system 4 is located at least partially in the European Union), the NL-Alert system (e.g., when system 4 is located at least partially in the Netherlands), the Emergency Mobile Alerts (EMA) system (e.g., when system 4 is located at least partially in New Zealand), and/or any other system that transmits or broadcasts emergency alert messages 28 for distribution to UE devices 10 at least partially through a cellular network such as cellular network 22.

Emergency alert message 28 may include information identifying a nominal alert region 20, a message body (e.g., a text string to convey emergency information to persons reading the message), and optionally additional information about or relevant to the emergency alert message (e.g., a severity level of the emergency, a time period during which the emergency alert message is to remain active, supplemental information such as resources for a user of a UE device to use to find help or reach safety, etc.). Nominal alert region 20 may be the geographic region within which emergency alert originator 18 intends to transmit emergency alert message 28 (e.g., the geographic region relevant to the emergency alert message, a geographic region containing an emergency situation, etc.). Nominal alert region 20 may, for example, extend across (span) one or more city blocks, some or all of one or more zip codes, some or all of one or more area codes, some or all of one or more towns, some or all of one or more buildings, some or all of one or more campuses, some or all of one or more towns, some or all of one or more cities, some or all of one or more counties, some or all of one or more states or provinces, some or all of one or more countries, some or all of one or more regions, some or all of one or more regions, or some or all of one or more continents.

Nominal alert region 20 may be defined or bounded by a corresponding perimeter 24. Perimeter 24 is sometimes referred to herein as geofence 24. Nominal alert region 20 may also be defined by one or more vertices 26 (e.g., corners of nominal alert region 20). Geofence 24 extends between each adjacent pair of vertices 26 to surround and enclose a continuous nominal alert region 20. Emergency alert message 28 may identify nominal alert region 20 in any desired manner. In a simplest case, emergency alert message 28 includes information identifying each of the vertices 26 of nominal alert region 20. Emergency alert message 28 may, for example, include or identify the latitude and longitude coordinates of each vertex 26 of nominal alert region 20 (e.g., as respective floating point values). This may be sufficient information for UE device 10 to identify nominal alert region 20 while consuming as little data within emergency alert message 28 as possible. For example, upon receiving the emergency alert message, UE device 10 may reconstruct nominal alert region 20 by constructing geofence 24 between each of the vertices 26 received in the emergency alert message and identifying nominal alert region 20 as the area bounded by geofence 24.

This is illustrative and non-limiting and, in general, emergency alert message 28 may identify nominal alert region 20 in any desired manner (e.g., by providing information identifying the coordinates or lines of geofence 24, information identifying the area/shape of nominal alert region 20 and the coordinates of at least one point within nominal alert region 20, etc.). Nominal alert region 20 may have any shape and any size. Nominal alert region 20 may, for example, be represented by a polygon having any desired number of sides and corresponding vertices 26. Emergency alert message 28 may include sufficient space to identify the latitude and longitude coordinates of up to 10-200 vertices 26 with a given level of precision, for example.

Cellular network 22 may receive the emergency alert message 28 broadcast by emergency alert originator 18 over communication link 23. Communication link 23 may include one or more wired and/or wireless links, sub-networks, the Internet, etc. Cellular network 22 may schedule transmission of the emergency alert message (e.g., using scheduler 2) based on the contents of the emergency alert message. For example, cellular network 22 may select one or more cells 8 that partially or completely overlap nominal alert region 20 and may then use the base stations 12 in the selected cells 8 to broadcast the emergency alert message to UE devices 10 located within the selected cells 8. The selected cells form a corresponding carrier alert region across which the emergency alert message is broadcasted. For example, cellular network 22 may generate a carrier alert region that includes cells 8-1 and 8-2, which overlap nominal alert region 20.

In practice, the carrier alert region does not exactly match nominal alert region 20. This is because emergency alert originator 18 does not typically have knowledge of the cells 8 that are in use by a given cellular network 22 at a given time, emergency alert originator 18 may define the bounds of nominal alert region 20 using different methodology than cellular network 22, the area relevant to the alert (e.g., the area in which an emergency is occurring) is often different from the area spanned by one or more cells 8 of cellular network 22, and carriers of different cellular networks 22 have different policies for defining regions in which to broadcast emergency alert messages received from emergency alert originator 18. For example, many carriers often overshoot the nominal alert region when generating a carrier alert region.

Rather than simply forwarding emergency alert message 28 to UE devices, cellular network 22 instead generates a carrier alert message 28B based on emergency alert message 28 and broadcasts carrier alert message 28B within the selected cells 8 (the carrier alert region). Carrier alert message 28B includes the message body, information identifying the carrier alert region (e.g., a list of coordinates of the vertices of polygons and/or circles that may define the carrier alert region), and some or all of the other information from the message. When a UE device receives the carrier alert message, the UE device monitors its location and compares its location to the carrier alert region identified by the carrier alert message. If the UE device is within the carrier alert region identified by the carrier alert message, the UE device displays the carrier alert message (e.g., the message body of emergency alert message 28) to inform its user of the emergency situation and may subsequently monitor the emergency. If the UE device is outside the carrier alert region, the UE device ignores or discards the carrier alert message without informing its user of the emergency situation. Cellular network 22 may continue to broadcast carrier alert message 28B for the duration of the time period identified by emergency alert message 28 (e.g., the time period during which the emergency alert message is active) and/or as long as cellular network 22 continues to receive the emergency alert message 28 from emergency alert originator 18. Each base station 12 in the carrier alert region broadcasts carrier alert message 28B over a broadcast channel.

Core network 14 may also receive the emergency alert message 28 broadcast by emergency alert originator 18 over communication link 25 (e.g., in parallel with cellular network 22). Communication link 25 may include one or more wired and/or wireless links, sub-networks, the Internet, etc. Core network 14 may include, for example, one or more nodes (e.g., servers, devices, sub-networks, etc.) such as a cloud region associated with UE device 10 and/or the operating system of UE device 10. Core network 14 may be owned, operated, and/or managed by a different entity than cellular network 22 and emergency alert originator 18 (e.g., an entity associated with UE device 10 and/or the operating system of UE device 10).

Core network 14 may, for example, include a safety alerts infrastructure that generates respective network alert messages 28A for each emergency alert message 28 broadcast by emergency alert originator 18. Core network 14 may transmit network alert messages 28A to UE device 10 via communications link 6. Communications link 6 may include one or more wired and/or wireless links. Communications link 6 may include one or more cellular telephone links (e.g., through cellular network 22 and base station 12-1), one or more wireless local area network links (e.g., when UE device 10 is connected to a wireless local area network), one or more wireless personal area network links, one or more device-to-device (D2D) links, the Internet, etc.

Core network 14 may transmit network alert messages 28A to UE device 10 over communications link 6 using the Hypertext Transfer Protocol (HTTP). Core network 14 may transmit (e.g., push) a given network alert message 28A to UE device 10 once rather than continuing to broadcast network alert message 28A (unlike cellular network 22, which continues to broadcast carrier alert message 28B over a broadcast channel of base station(s) 12).

To preserve the privacy of UE device 10, core network 14 has no knowledge of the location of UE device 10 (e.g., core network 14 does not store the location of UE device 10). As such, core network 14 has no knowledge of which UE devices 10 are within nominal alert region 20 and thus need to receive emergency alert 28. This is in contrast to cellular network 22, which is aware of which UE devices are registered to the cells 8 of the carrier alert region. Core network 14 may therefore transmit network alert messages 28A to UE device 10 for all emergency alert messages 28 that are generated by emergency alert originator 18 regardless of where nominal alert region 20 and UE device 10 are located on Earth. Each network alert message 28A may include the message body, information identifying a network alert region (e.g., coordinates of the vertices of a polygon that defines the network alert region, which may be the same as nominal alert region 20 or which may be modified from nominal alert region 20 based on one or more policies of core network 14), and some or all of the other information from the corresponding emergency alert message 28.

UE device 10 may store each of the network alert messages 28A received from core network 14. In this way, core network 14 configures UE device 10 to have knowledge of all active emergency alert messages 28 transmitted by emergency alert originator 18 regardless of location. When UE device 10 is at a location that is within the carrier alert region associated with a particular emergency alert message 28, UE device 10 will eventually receive the corresponding carrier alert message 28B from cellular network 22. UE device 10 may use the stored network alert messages 28A to optimize when and how the UE device displays the message body associated with carrier alert message 28B to the user of the UE device.

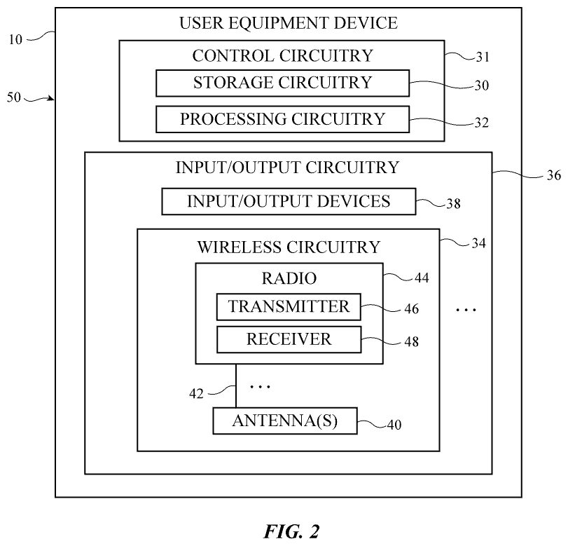

FIG. 2 is a block diagram of UE device 10. UE device 10 is an electronic device and may therefore sometimes be referred to herein as electronic device 10 or device 10. UE device 10 may be a computing device such as a laptop computer, a desktop computer, a computer monitor containing an embedded computer, a tablet computer, a cellular telephone, a media player, or other handheld or portable electronic device, a smaller device such as a wristwatch device, a pendant device, a headphone or earpiece device, a device embedded in eyeglasses or other equipment worn on a user's head, or other wearable or miniature device, a television, a computer display that does not contain an embedded computer, a gaming device, a navigation device, an embedded system such as a system in which electronic equipment with a display is mounted in a kiosk or automobile, a wireless internet-connected voice-controlled speaker, a home entertainment device, a remote control device, a gaming controller, a peripheral user input device, a wireless base station or access point, equipment that implements the functionality of two or more of these devices, or other electronic equipment.

As shown in FIG. 2, UE device 10 may include components located on or within an electronic device housing such as housing 50. Housing 50, which may sometimes be referred to as a case, may be formed of plastic, glass, ceramics, fiber composites, metal (e.g., stainless steel, aluminum, metal alloys, etc.), other suitable materials, or a combination of these materials. In some situations, part or all of housing 50 may be formed from dielectric or other low-conductivity material (e.g., glass, ceramic, plastic, sapphire, etc.). In other situations, housing 50 or at least some of the structures that make up housing 50 may be formed from metal elements.

UE device 10 may include control circuitry 31. Control circuitry 31 may include storage such as storage circuitry 30. Storage circuitry 30 may include hard disk drive storage, nonvolatile memory (e.g., flash memory or other electrically-programmable-read-only memory configured to form a solid-state drive), volatile memory (e.g., static or dynamic random-access-memory), etc. Storage circuitry 30 may include storage that is integrated within UE device 10 and/or removable storage media.

Control circuitry 31 may include processing circuitry such as processing circuitry 32. Processing circuitry 32 may be used to control the operation of UE device 10. Processing circuitry 32 may include on one or more processors such as microprocessors, microcontrollers, digital signal processors, host processors, baseband processor integrated circuits, application specific integrated circuits, central processing units (CPUs), graphics processing units (GPUs), etc. Control circuitry 31 may be configured to perform operations in UE device 10 using hardware (e.g., dedicated hardware or circuitry), firmware, and/or software. Software code for performing operations in UE device 10 may be stored on storage circuitry 30 (e.g., storage circuitry 30 may include non-transitory (tangible) computer readable storage media that stores the software code). The software code may sometimes be referred to as program instructions, software, data, instructions, or code. Software code stored on storage circuitry 30 may be executed by processing circuitry 32.

Control circuitry 31 may be used to run software on device 10 such as one or more software applications (sometimes referred to herein simply as applications or apps). The applications (e.g., QoS applications and nQoS applications) may be stored at storage circuitry 30. The applications may include satellite navigation applications, internet browsing applications, voice-over-internet-protocol (VOIP) telephone call applications, email applications, media playback applications, operating system functions, gaming applications, productivity applications, workplace applications, augmented reality (AR) applications, extended reality (XR) applications, virtual reality (VR) applications, scheduling applications, consumer applications, social media applications, educational applications, banking applications, spatial ranging applications, sensing applications, security applications, media applications, streaming applications, automotive applications, video editing applications, image editing applications, rendering applications, simulation applications, camera-based applications, imaging applications, news applications, and/or any other desired software applications. The applications may generate and/or receive corresponding wireless data (e.g., when executed by an application processor).

To support interactions with external communications equipment, control circuitry 31 may be used in implementing communications protocols. Communications protocols that may be implemented using control circuitry 31 include internet protocols, wireless local area network (WLAN) protocols (e.g., IEEE 802.11 protocols-sometimes referred to as Wi-Fi®), protocols for other short-range wireless communications links such as the Bluetooth® protocol or other wireless personal area network (WPAN) protocols, IEEE 802.11ad protocols (e.g., ultra-wideband protocols), cellular telephone protocols (e.g., 3G protocols, 3rd Generation Partnership Project (3GPP) Fourth Generation (4G) Long Term Evolution (LTE) protocols, 3GPP Fifth Generation (5G) New Radio (NR) protocols, 6G protocols, cellular sideband protocols, etc.), device-to-device (D2D) protocols, antenna diversity protocols, satellite navigation system protocols (e.g., global positioning system (GPS) protocols, global navigation satellite system (GLONASS) protocols, etc.), satellite communications protocols (e.g., for conveying bi-directional data with one or more gateways via one or more communications satellites in a satellite constellation, antenna-based spatial ranging protocols, or any other desired communications protocols. Each communications protocol may be associated with a corresponding radio access technology (RAT) that specifies the physical connection methodology used in implementing the protocol (e.g., an NR RAT, an LTE RAT, a 3G RAT, a WLAN RAT, etc.). Radio-frequency signals conveyed using a cellular telephone protocol (e.g., radio-frequency signals 16 of FIG. 1) may sometimes be referred to herein as cellular telephone signals.

UE device 10 may include input-output circuitry 36. Input-output circuitry 36 may include input-output devices 38. Input-output devices 38 may be used to allow data to be supplied to UE device 10 and to allow data to be provided from UE device 10 to external devices. Input-output devices 38 may include user interface devices, data port devices, and other input-output components. For example, input-output devices 38 may include touch sensors, displays (e.g., touch-sensitive and/or force-sensitive displays), light-emitting components such as displays without touch sensor capabilities, buttons (mechanical, capacitive, optical, etc.), scrolling wheels, touch pads, key pads, keyboards, microphones, cameras, buttons, speakers, status indicators, audio jacks and other audio port components, digital data port devices, motion sensors (accelerometers, gyroscopes, and/or compasses that detect motion), capacitance sensors, proximity sensors, magnetic sensors, force sensors (e.g., force sensors coupled to a display to detect pressure applied to the display), temperature sensors, etc. In some configurations, keyboards, headphones, displays, pointing devices such as trackpads, mice, and joysticks, and other input-output devices may be coupled to UE device 10 using wired or wireless connections (e.g., some of input-output devices 38 may be peripherals that are coupled to a main processing unit or other portion of UE device 10 via a wired or wireless link).

Input-output circuitry 36 may include wireless circuitry 34 to support wireless communications. Wireless circuitry 34 (sometimes referred to herein as wireless communications circuitry 34) may include one or more antennas 40. Wireless circuitry 34 may also include one or more radios 44. Radio 44 may include circuitry that operates on signals at baseband frequencies (e.g., baseband circuitry) and radio-frequency transceiver circuitry such as one or more radio-frequency transmitters 46 and one or more radio-frequency receivers 48. Transmitter 46 may include signal generator circuitry, modulation circuitry, mixer circuitry for upconverting signals from baseband frequencies to intermediate frequencies and/or radio frequencies, amplifier circuitry such as one or more power amplifiers, digital-to-analog converter (DAC) circuitry, control paths, power supply paths, switching circuitry, filter circuitry, and/or any other circuitry for transmitting radio-frequency signals using antenna(s) 40. Receiver 48 may include demodulation circuitry, mixer circuitry for downconverting signals from intermediate frequencies and/or radio frequencies to baseband frequencies, amplifier circuitry (e.g., one or more low-noise amplifiers (LNAs)), analog-to-digital converter (ADC) circuitry, control paths, power supply paths, signal paths, switching circuitry, filter circuitry, and/or any other circuitry for receiving radio-frequency signals using antenna(s) 40. The components of radio 44 may be mounted onto a single substrate or integrated into a single integrated circuit, chip, package, or system-on-chip (SOC) or may be distributed between multiple substrates, integrated circuits, chips, packages, or SOCs.

Antenna(s) 40 may be formed using any desired antenna structures for conveying radio-frequency signals. For example, antenna(s) 40 may include antennas with resonating elements that are formed from loop antenna structures, patch antenna structures, inverted-F antenna structures, slot antenna structures, planar inverted-F antenna structures, helical antenna structures, monopole antennas, dipoles, hybrids of these designs, etc. Filter circuitry, switching circuitry, impedance matching circuitry, and/or other antenna tuning components may be adjusted to adjust the frequency response and wireless performance of antenna(s) 40 over time. If desired, two or more of antennas 40 may be integrated into a phased antenna array (sometimes referred to herein as a phased array antenna) in which each of the antennas conveys radio-frequency signals with a respective phase and magnitude that is adjusted over time so the radio-frequency signals constructively and destructively interfere to produce a signal beam in a given/selected beam pointing direction (e.g., towards base station 12 of FIG. 1).

The term “convey radio-frequency signals” as used herein means the transmission and/or reception of the radio-frequency signals (e.g., for performing unidirectional and/or bidirectional wireless communications with external wireless communications equipment). Similarly, the term “convey wireless data” as used herein means the transmission and/or reception of wireless data using radio-frequency signals. Antenna(s) 40 may transmit the radio-frequency signals by radiating the radio-frequency signals into free space (or to free space through intervening device structures such as a dielectric cover layer). Antenna(s) 40 may additionally or alternatively receive the radio-frequency signals from free space (e.g., through intervening devices structures such as a dielectric cover layer). The transmission and reception of radio-frequency signals by antennas 40 each involve the excitation or resonance of antenna currents on an antenna resonating element in the antenna by the radio-frequency signals within the frequency band(s) of operation of the antenna.

Each radio 44 may be coupled to one or more antennas 40 over one or more radio-frequency transmission lines 42. Radio-frequency transmission lines 42 may include coaxial cables, microstrip transmission lines, stripline transmission lines, edge-coupled microstrip transmission lines, edge-coupled stripline transmission lines, transmission lines formed from combinations of transmission lines of these types, etc. Radio-frequency transmission lines 42 may be integrated into rigid and/or flexible printed circuit boards if desired. One or more radio-frequency lines 42 may be shared between multiple radios 44 if desired. Radio-frequency front end (RFFE) modules may be interposed on one or more radio-frequency transmission lines 42. The radio-frequency front end modules may include substrates, integrated circuits, chips, or packages that are separate from radios 44 and may include filter circuitry, switching circuitry, amplifier circuitry, impedance matching circuitry, radio-frequency coupler circuitry, and/or any other desired radio-frequency circuitry for operating on the radio-frequency signals conveyed over radio-frequency transmission lines 42.

Radio 44 may transmit and/or receive radio-frequency signals within corresponding frequency bands at radio frequencies (sometimes referred to herein as communications bands or simply as “bands”). The frequency bands handled by radio 44 may include wireless local area network (WLAN) frequency bands (e.g., Wi-Fi® (IEEE 802.11) or other WLAN communications bands) such as a 2.4 GHz WLAN band (e.g., from 2400 to 2480 MHZ), a 5 GHZ WLAN band (e.g., from 5180 to 5825 MHZ), a Wi-Fi® 6E band (e.g., from 5925-7125 MHZ), and/or other Wi-Fi® bands (e.g., from 1875-5160 MHZ), wireless personal area network (WPAN) frequency bands such as the 2.4 GHz Bluetooth® band or other WPAN communications bands, cellular telephone frequency bands (e.g., bands from about 600 MHz to about 5 GHZ, 3G bands, 4G LTE bands, 5G New Radio Frequency Range 1 (FR1) bands below 10 GHz, 5G New Radio Frequency Range 2 (FR2) bands between 20 and 60 GHz, cellular sidebands, 6G bands between 100-1000 GHZ (e.g., sub-THz, THz, or THF bands), etc.), other centimeter or millimeter wave frequency bands between 10-300 GHz, near-field communications frequency bands (e.g., at 13.56 MHZ), satellite navigation frequency bands (e.g., a GPS band from 1565 to 1610 MHz, a Global Navigation Satellite System (GLONASS) band, a BeiDou Navigation Satellite System (BDS) band, etc.), ultra-wideband (UWB) frequency bands that operate under the IEEE 802.15.4 protocol and/or other ultra-wideband communications protocols, communications bands under the family of 3GPP wireless communications standards, communications bands under the IEEE 802.XX family of standards, industrial, scientific, and medical (ISM) bands such as an ISM band between around 900 MHz and 950 MHz or other ISM bands below or above 1 GHz, one or more unlicensed bands, one or more bands reserved for emergency and/or public services, and/or any other desired frequency bands of interest. Wireless circuitry 34 may also be used to perform spatial ranging operations if desired.

The example of FIG. 2 is illustrative and non-limiting. While control circuitry 31 is shown separately from wireless circuitry 34 in the example of FIG. 1 for the sake of clarity, wireless circuitry 34 may include processing circuitry (e.g., one or more processors) that forms a part of processing circuitry 32 and/or storage circuitry that forms a part of storage circuitry 30 of control circuitry 31 (e.g., portions of control circuitry 31 may be implemented on wireless circuitry 34). As an example, control circuitry 31 may include baseband circuitry (e.g., one or more baseband processors), digital control circuitry, analog control circuitry, and/or other control circuitry that forms part of radio 44. The baseband circuitry may, for example, access a communication protocol stack on control circuitry 31 (e.g., storage circuitry 30) to: perform user plane functions at a PHY layer, MAC layer, RLC layer, PDCP layer, SDAP layer, and/or PDU layer, and/or to perform control plane functions at the PHY layer, MAC layer, RLC layer, PDCP layer, RRC, layer, and/or non-access stratum (NAS) layer. If desired, the PHY layer operations may additionally or alternatively be performed by radio-frequency (RF) interface circuitry in wireless circuitry 34.

In practice, UE device 10 may receive a network alert message 28A from core network 14 for a given emergency alert message 28 prior to receiving the corresponding carrier alert message 28B from cellular network 22 (FIG. 1). This may be because cellular network 22 requires time to generate carrier alert message 28B from emergency alert message 28 and/or because the broadcast channel of base stations 12 has very limited bandwidth. In addition, UE device 10 may need to wait until it receives carrier alert message 28B prior to displaying the emergency alert message to comply with service agreements in place with the cellular carrier. However, it is desirable for UE device 10 to be able to display emergency alert message 28 as soon after the first transmission by emergency alert originator 18 as possible to maximize the likelihood that the user of UE device 10 will be able to reach safety.

Further, the carrier alert region identified by carrier alert message 28B may differ from nominal alert region 20 due to non-overlap between the cells 8 of cellular network 22 and nominal alert region 20 and/or due to the carrier's emergency broadcast policies, which can differ between cellular networks 22. This can cause some UE devices 10 to not receive a relevant carrier alert message 28B, putting the users of those UE devices at risk in an emergency situation, and/or can cause more UE devices than necessary to be informed of the alert. In general, care should be taken to prevent UE devices far from an emergency situation from erroneously displaying an irrelevant alert message, which can create unnecessary traffic, congestion, or panic (e.g., situations that could make the emergency situation worse), and/or can detriment user experience. To help mitigate these issues (e.g., to minimize the likelihood of missing a relevant emergency alert message 28 and/or to minimize the time required to display an emergency message), UE device 10 may use the network alert messages 28A received from core network 14 to help determine how and when to display the message body of an emergency alert message 28 transmitted by emergency alert originator 18.

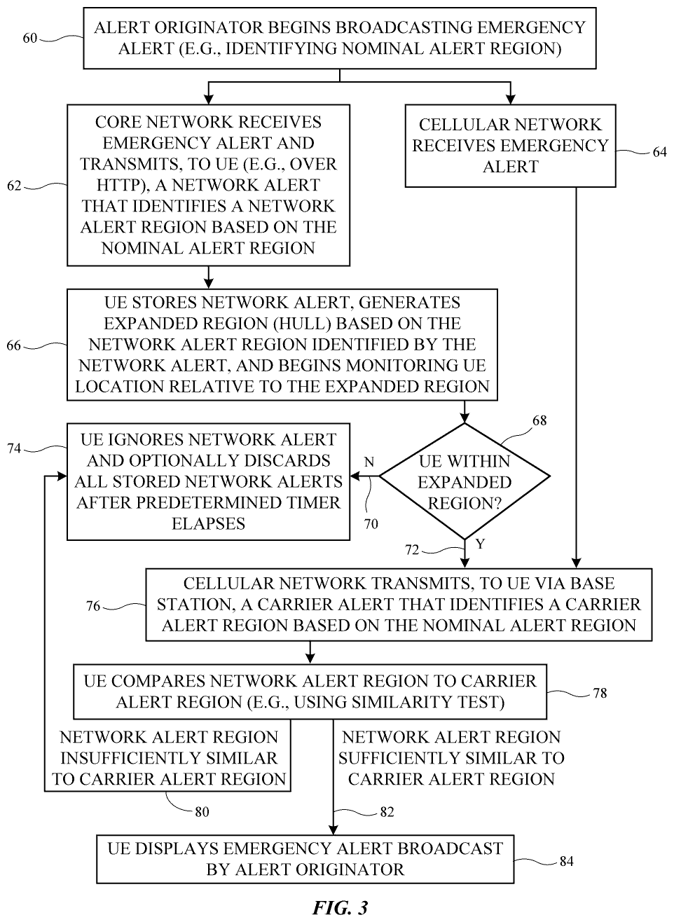

FIG. 3 is a flow chart of operations that may be performed by UE device 10 to display the message body of an emergency alert message 28 based on a network alert messages 28A received from core network 14.

At operation 60, emergency alert originator 18 may begin broadcasting emergency alert message 28 to the nodes of system 4 (e.g., in response to an emergency that is occurring or that will soon occur within nominal alert region 20 somewhere on Earth). Emergency alert message 28 may include information identifying nominal alert region 20 (e.g., vertices 26). Operations 62 and 64 may be performed concurrently.

At operation 62, core network 14 receives emergency alert message 28 from emergency alert originator 18. Core network 14 processes emergency alert message 28 and generates a network alert message 28A corresponding to the received emergency alert message 28. Network alert message 28A may include information identifying a corresponding network alert region (e.g., floating point values identifying latitude and longitude coordinates of vertices of a polygon defining the network alert region). The network alert region may be the same as nominal alert region 20 or may be different from nominal alert region 20. The network alert region may be different from nominal alert region, for example, when core network 14 alters nominal alert region 20 (e.g., according to an emergency broadcast or safety policy of core network 14), when core network 14 does not correctly receive all of the vertices 26 of nominal alert region 20 from emergency alert message 28, due to rounding of the coordinates of vertices 26 by core network 14 in a manner that changes the precision with which the network alert region is defined relative to as defined in emergency alert message 28, and/or due to any other reason. Core network 14 may transmit network alert message 28A to UE device 10 over communications link 6 (e.g., as a one-time push over HTTP).

At operation 64, cellular network 22 receives emergency alert message 28 from emergency alert originator 18. Cellular network 22 begins processing emergency alert message 28. For example, cellular network 22 may generate carrier alert message 28B based on emergency alert message 28. Carrier alert message 28B may include information identifying a corresponding carrier alert region (e.g., floating point values identifying latitude and longitude coordinates of vertices of a polygon defining the carrier alert region). In practice, the carrier alert region is likely to be different than nominal network region 20 and/or the network alert region identified by network alert message 28A. Due to the limited bandwidth of the broadcast channel, the limited processing speed of cellular network 22, and/or the emergency message broadcast policies of cellular network 22, transmission of carrier alert message 28B may be delayed for a non-trivial amount of time (e.g., until operation 76, which may occur after operation 68 or concurrent with operation 66 and/or 68).

At operation 66, UE device 10 receives network alert message 28A from core network 14 over communications link 6 (e.g., using HTTP). UE device 10 stores network alert message 28A at storage circuitry 30 (FIG. 2) (e.g., with all other active network alerts received from core network 14). Rather than waiting for UE device 10 to receive the carrier alert message 28B corresponding to network alert message 28A, UE device 10 may proactively begin processing the stored network alert message 28A (e.g., to prepare UE device 10 for the eventual receipt of carrier alert message 28B). This may serve to minimize the amount of time after the eventual receipt of carrier alert message 28B until the message body of emergency alert message 28 is displayed by UE device 10.

For example, control circuitry 31 (FIG. 1) may generate an expanded alert region based on the network alert region identified in network alert message 28A. The expanded alert region (sometimes also referred to herein as a hull or an augmented hull) is larger than and encloses the network alert region and/or nominal alert region 20. The expanded alert region may allow for more margin of safety in having UE device 10 display the emergency alert, allows the UE device to perform geofencing that is agnostic of which cellular network the UE device is registered to, and allows the UE device more flexibility in displaying the emergency alert. The size of the whole may depend on the speed of the UE device, the severity level of the alert, and/or other factors.

Control circuitry 31 may then begin monitoring the location of UE device 10 based on (relative to) the expanded alert region. For example, one or more sensors on UE device 10 may measure (e.g., detect, identify, generate, calculate, compute, output, etc.) the location of UE device 10. Control circuitry 31 may identify the location of UE device 10 from the measurements performed by the one or more sensors. In general, the one or more sensors may include a satellite navigation receiver, light-based sensors, acoustic sensors, proximity sensors, orientation or motion sensors, and/or other sensors (e.g., in input/output devices 38 and/or wireless circuitry 34 of FIG. 2).

In implementations where control circuitry 31 monitors the location of UE device 10 using a satellite navigation receiver, for example, the satellite navigation receiver may be inactive (e.g., powered off, idle, asleep, etc.) prior to beginning to monitor the location of UE device 10 (e.g., prior to operation 66). This may serve to minimize power consumption on UE device 10 and conserve battery. When control circuitry 31 begins to monitor the location of UE device 10 using the satellite navigation receiver, control circuitry 31 activates (e.g., powers on, wakes, etc.) the satellite navigation receiver. In practice, there may be a substantial delay time between when the satellite navigation receiver is activated and when the satellite navigation receiver is able to receive sufficient satellite navigation signals to identify (e.g., triangulate) the location of UE device 10 (e.g., as long as 45 seconds). By beginning to monitor the location of UE device 10 without first waiting to receive carrier alert message 28B, UE device 10 can minimize the amount of time required to identify whether UE device 10 is at a location relevant to the nominal alert region, thereby minimizing the amount of time required before UE device 10 displays the message body (payload) of emergency alert message 28.

At operation 68, while monitoring the location of UE device 10, control circuitry 31 determines (e.g., identifies, detects, computes, etc.) whether UE device 10 is located within the expanded alert region. If/when UE device 10 is not located within the expanded region, the emergency alert message 28 associated with network alert message 28A is not relevant to UE device 10 because UE device 10 is located sufficiently far from nominal alert region 20 (e.g., UE device 10 is not located within nominal alert region 20 and is sufficiently unlikely to move into nominal alert region 20), and processing proceeds to operation 74 via path 70. The comparison of the location of UE device 10 to a region identified by emergency alert message 28 (e.g., geofence 24) is sometimes referred to as geofencing. The generation of an expanded alert region based on the geofence identified by emergency alert message 28 and the comparison of the location of UE device 10 to the expanded alert region is sometimes also referred to herein as performing a Neighborhood test (N-test).

At operation 74, UE device 10 ignores network alert message 28A since it is not relevant to the current or likely future location of UE device 10. If desired, UE device 10 may discard or delete all stored network alert messages if UE device 10 has not moved into the expanded region for those network alert messages after a predetermined amount of time has elapsed (e.g., 5 minutes). On the other hand, if/when UE device 10 is located within the expanded alert region, the emergency alert message 28 associated with network alert message 28A is relevant to UE device 10 (e.g., because UE device 10 is located within nominal alert region 20, is sufficiently close to nominal alert region 20, or is likely to move into nominal alert region 20), and processing proceeds from operation 68 to operation 76 via path 72.

At operation 76, cellular network 22 (e.g., base station 12-1 of FIG. 1) transmits the carrier alert message 28B corresponding to emergency alert message 28 and the stored network alert message 28A to UE device 10 (e.g., using radio-frequency signals 16 of FIG. 1). By this time, UE device 10 has already begun processing the corresponding network alert message 28A (e.g., at operations 66 and 68) and determined that the emergency alert message 28 corresponding to network alert message 28A and carrier alert message 28B is relevant to the UE device at its current location. As such, UE device 10 does not need to consume any additional time before advancing to operation 78 (e.g., does not need to wait for the satellite navigation receiver to wake and receive a sufficient amount of satellite navigation signals to triangulate the location of UE device 10).

At operation 78, UE device 10 compares the network alert region identified by network alert message 28A to the carrier alert region identified by carrier alert message 28B. For example, control circuitry 31 may perform a similarity test (sometimes referred to herein as an S-test) on the carrier alert region and the network alert region. The S-test may, for example, help to ensure that the network alert region is sufficiently reliable to continue to use for geofencing given that carriers may overshoot or otherwise distort the nominal alert region, core network 14 may convert circles (e.g., as identified by emergency alert message 28) into polygons, county code to shapes translations can distort the network alert region, parsing bugs may be present, etc.

If/when the network alert region is not sufficiently similar to the carrier alert region (e.g., if the similarity test outputs a similarity score less than or equal to a threshold value or the carrier alert and network alert regions exhibit less than a threshold level of similarity), the network alert region is insufficiently reliable and processing may loop back to operation 74 via path 80. If desired, UE device 10 may display the message body of the received carrier alert message 28B and/or perform the N-test based on the carrier and/or network alert region.

On the other hand, if/when the network alert region is sufficiently similar to the carrier alert region (e.g., if the similarity test outputs a similarity score greater than the threshold value or the carrier alert and network alert regions exhibit more than a threshold level of similarity), the network alert region is sufficiently reliable and processing proceeds from operation 78 to operation 84 via path 82. At operation 84, UE device 10 outputs some or all of emergency alert message 28 (e.g., as identified by network alert message 28A and/or carrier alert message 28B) to the user of UE device 10. For example, UE device 10 may display an alert or notification on the display of UE device 10 to inform the user of the emergency (e.g., the alert or notification may include the message body of emergency alert message 28). Additionally or alternatively, UE device 10 may issue a haptic alert, an audio alert, and/or other types of alerts or notifications. Once the user has been informed of the emergency, the user can take actions to find safety.

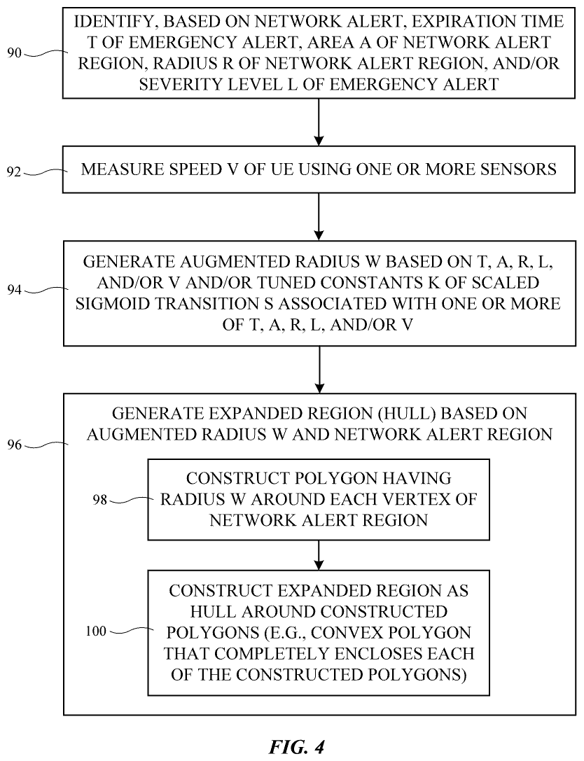

FIG. 4 is a flow chart of operations that may be performed by control circuitry 31 to generate the expanded alert region for use in performing geofencing. The operations of FIG. 4 may, for example, be performed while processing operation 66 of FIG. 3. Control circuitry 31 may perform one or more of these operations using an application processor, for example.

At operation 90, control circuitry 31 may process network alert message 28A to identify an expiration time T of emergency alert message 28, the area A of the network alert region identified by network alert message 28A, the radius R of the network alert region identified by network alert message 28A, and/or the severity level L of emergency alert message 28. Network alert message 28A may, for example, include information identifying expiration time T and severity level L.

Control circuitry 31 may calculate, generate, compute, determine, or otherwise determine area A and radius R from the information in network alert message 28A identifying the network alert area (e.g., the coordinates of the vertices of the network alert area as identified by network alert message 28A). For example, control circuitry 31 may construct (e.g., calculate or generate) a geofence connecting adjacent vertices of the network alert area. Control circuitry 31 may then calculate the area of the network alert area based on the geofence (e.g., the area bound by the geofence). Control circuitry 31 may calculate radius R using the equation R=sqrt(A/π)/2 (e.g., approximating the network alert area to a unidimensional metric which linearly and visually tunable).

At operation 92, control circuitry 31 may identify the speed V of UE device 10 using one or more sensors (e.g., the satellite navigation receiver, an accelerometer, etc.). Operation 92 may be omitted if desired.

At operation 94, control circuitry 31 may generate (e.g., compute, calculate, output, identify, etc.) an augmented radius W based on expiration time T, area A, radius R, severity level L, speed V, and/or other factors. Augmented radius W corresponds to the size of the expanded alert region relative to the network alert region. If desired, augmented radius W may be larger when expiration time T is longer than when expiration time T is shorter (e.g., because UE device 10 can travel farther over a longer time than a shorter time). Additionally or alternatively, augmented radius W may be larger when severity level L is higher than when severity level L is lower (e.g., because more severe emergencies are more likely to affect larger areas). Additionally or alternatively, augmented radius W may be larger when speed V is higher than when speed V is lower (e.g., because UE device 10 will travel farther when speed V is higher than when speed V is lower). Additionally or alternatively, augmented radius W may be larger when radius R is greater than when radius R is lower.

In general, control circuitry 31 may generate augmented radius W as a function of expiration time T, area A, radius R, severity level L, and/or speed V. For example, control circuitry 31 may generate augmented radius W as a function of the Scaled Sigmoid Transition S of T, A, R, L, and/or V. The Scaled Sigmoid Transition S is defined by the equation S(x)=k₁/(1+exp(k₂(k₃−x)), where parameter x is T, A, R, L, or V, and k₁, k₂, and k₃ are tuning constants that are adjusted to tune the size and/or shape of the expanded alert area relative to the network alert area. Control circuitry 31 may adjust constants k₁, k₂, and/or k₃ over time and/or core network 14 may transmit signals to UE device 10 that instruct UE device 31 to set constants k₁, k₂, and/or k₃ to particular values (e.g., to conform to updated safety policies implemented by core network 14). This may, for example, allow for Visual tuning, for some or all factors to be quickly neutered, for customization for different carriers, and/or for the addition of additional factors.

In general, S(x) is equal to a number between zero and one. Constant k₁ may allow for custom output clipping of S(x). A constant value of k₁=1 helps to produce the net effect of parameter x in the final calculation. Constant k₂ may allow for slope control of S(x). Constant k₃ may allow for a custom transition boundary for S(x). Control circuitry 31 may calculate augmented radius W, for example, using the equation W=S(V)×S(L)×S(T)×S(R). In general, augmented radius W will have a magnitude between zero miles and a maximum number of miles (e.g., 15 miles).

At operation 96, control circuitry 31 may generate (e.g., construct, compute, draw, calculate, output, produce, identify, etc.) the expanded alert region based on the network alert region identified by network alert message 28A and augmented radius W.

For example, at operation 98, control circuitry 31 may first construct (e.g., generate, compute, calculate, draw, identify, etc.) a respective polygon having augmented radius W centered around each vertex of the network alert region. The polygon may have any desired number of sides, where each side is separated from the center of the vertex by augmented radius W. As the number of sides of the polygon increases, the polygon more closely approximates a circle. The polygons may, for example, be polygons on a spherical surface.

At operation 100, control circuitry 31 may construct the expanded alert region as a hull around each of the polygons constructed at operation 98. A hull is a convex polygon (e.g., on a spherical surface) that completely surrounds and encloses a set of polygons (e.g., the polygons constructed around each of the vertices of the network alert region). Control circuitry 31 may then monitor the position of UE device 10 relative to the expanded alert region.

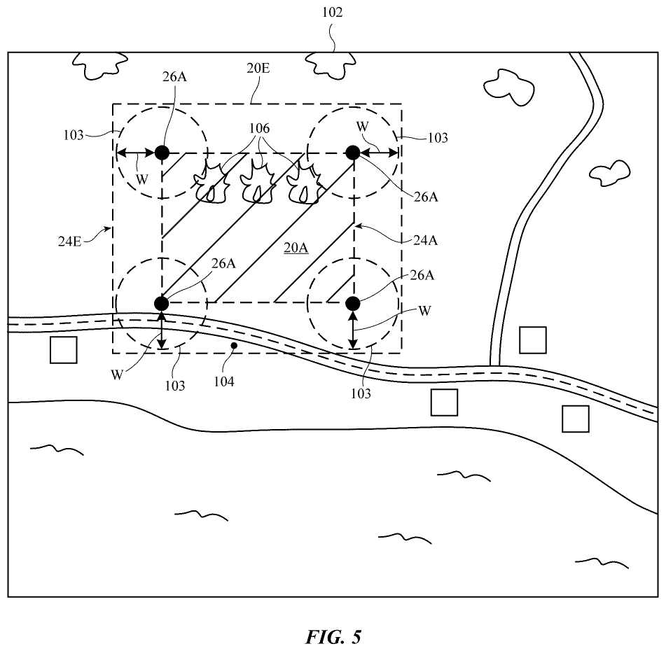

FIG. 5 shows one example of how control circuitry 31 may generate the expanded alert region as a hull around a set of polygons (e.g., while processing operation 66 of FIG. 3 and the operations of FIG. 4). As shown in FIG. 5, UE device 10 may be at a location 104 within geographic region/area 102.

UE device 10 may receive network alert message 28A. Network alert message 28A may identify a corresponding network alert region 20A. Network alert region 20A may be the same as nominal alert region 20 (FIG. 1) or may be different or modified from nominal alert region 20. Network alert region 20A may, for example, correspond to a part of geographic region 102 in which an emergency situation is occurring, such as wildfires 106. Emergency alert originator 18 (FIG. 1) may generate emergency alert message 28 (e.g., the emergency alert from which network alert message 28A was generated) in response to reports of wildfires 106, for example.

Network alert region 20A may be bound by a geofence 24A that connects the vertices 26A of network alert region 20A. Network alert message 28A may, for example, identify network alert region 20A by identifying the latitude and longitude coordinates of vertices 26A. Control circuitry 31 may reconstruct geofence 24A and thus network alert region 20A based on the coordinates of vertices 26A (e.g., by drawing geofence 24A as lines between vertices 26A that enclose a continuous geographic area).

Control circuitry 31 may generate an expanded alert region 20E corresponding to network alert region 20A (e.g., while processing the operations of FIG. 4). For example, control circuitry 31 may generate an augmented radius W (e.g., while processing operation 94 of FIG. 4). Control circuitry 31 may draw polygons 103 having augmented radius W (e.g., decimated circles, which are low resolution polygons derived from circles with radius W used for drawing augmented hulls), each centered around a respective vertex 26A of network alert region 20A (e.g., while processing operation 98 of FIG. 4). Control circuitry 31 may then draw expanded alert region 20E as a hull that surrounds and encloses polygons 103. Generating expanded alert region 20E in this way involves relatively few simple mathematical calculations that can be performed by control circuitry 31 very quickly and reliably.

In the example of FIG. 5, location 104 is outside of network alert region 20A. By generating expanded alert region 20E, UE device 10 is able to ensure that the user of UE device 10 is informed of the emergency situation (e.g., wildfires 106) even though UE device 10 would not have otherwise informed the user of the emergency situation had control circuitry 31 only compared location 104 to network alert region 20A. The example of FIG. 5 is illustrative and non-limiting. Network alert region 20A may have any desired shape and/or size (e.g., any desired number of vertices 26A), expanded alert region 20E may have any desired shape and/or size, and polygons 103 may have any desired shape.

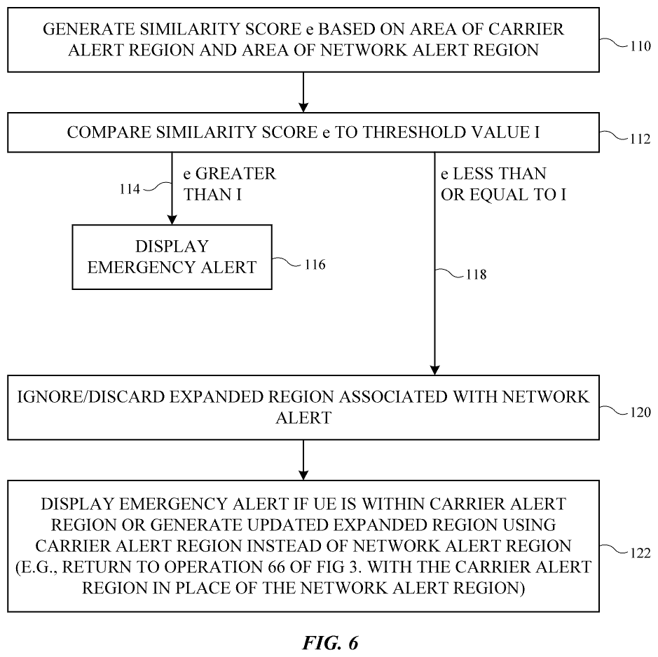

FIG. 6 is a flow chart of operations that may be performed by control circuitry 31 to determine whether the carrier alert region identified by carrier alert message 28B is sufficiently similar to the network alert region identified by network alert message 28A (e.g., to determine whether network alert region 20A satisfies the similarity test with the carrier alert region). The carrier alert region is sometimes referred to herein as carrier alert region 20B. The operations of FIG. 6 may, for example, be performed while processing operation 78 of FIG. 3. Control circuitry 31 may perform the operations of FIG. 6 using an application processor, for example.

At operation 110, control circuitry 31 may generate a similarity score e between network alert region 20A and carrier alert region 20B. Control circuitry 31 may, for example, generate (e.g., compute, calculate, identify, output, etc.) similarity score e using the equation e=(A_{N}∩A_{C})/MAX(A_{N},A_{C}), where A_{N}∩A_{C} is the area overlapped by both network alert region 20A and carrier alert region 20B, and MAX(A_{N},A_{C}) is the larger of the area A_{N} of network alert region 20A or the area A_{C} of carrier alert region A_{C}. The operation ∩ may be carried out on a spherical geometry.

At operation 112, control circuitry 31 may compare similarity score e to a threshold value I (e.g., 0.98, 0.99, 0.999, 0.9, etc.) using techniques such as scaled sigmoid transitions. Additionally or alternatively, control circuitry 31 may compare the coordinates of each vertex 26A for network alert region 20A to the coordinates of the vertices of carrier alert region 20B, sometimes also referred to herein as vertices 26B (e.g., in the time order with which the vertices are received in carrier alert message 28B to minimize processing time). If desired, control circuitry 31 may first compare the coordinates of vertices 26B to the coordinates of each vertex 26A as vertices 26B are received and may only perform operation 110 and comparison of similarity score e to threshold value I if one or more of vertices 26B has/have coordinates that differ from the coordinates of all vertices 26A by more than a threshold distance.

If/when similarity score e exceeds threshold value I (or all vertices 26B are less than a threshold distance from at least one vertex 26A), network alert region 20A is sufficiently similar to carrier alert region 20B and processing proceeds to operation 116 via path 114. At operation 116, UE device 10 displays the message body of the alert (e.g., at operation 84 of FIG. 3).

On the other hand, if/when similarity score e is less than threshold or equal to value I, network alert region 20A is insufficiently similar to carrier alert region 20B and processing proceeds from operation 112 to operation 120 via path 118. At operation 120, control circuitry 31 discards or ignores the expanded alert region 20E associated with network alert message 28A.

At operation 122, UE device 10 may monitor the location of UE device 10 relative to the carrier alert region 20B identified by carrier alert message 28B. UE device 10 may display the message body of the alert (e.g., at operation 84) if/when UE device 10 is located within carrier alert region 20B. Alternatively, control circuitry 31 may generate expanded alert region 20E based on carrier alert region 20B instead of network alert region 20A and may monitor the location of UE device 10 relative to the expanded alert region 20E around carrier alert region 20B (e.g., processing may return to operation 66 of FIG. 3 but with carrier alert region 20B replacing network alert region 20A).

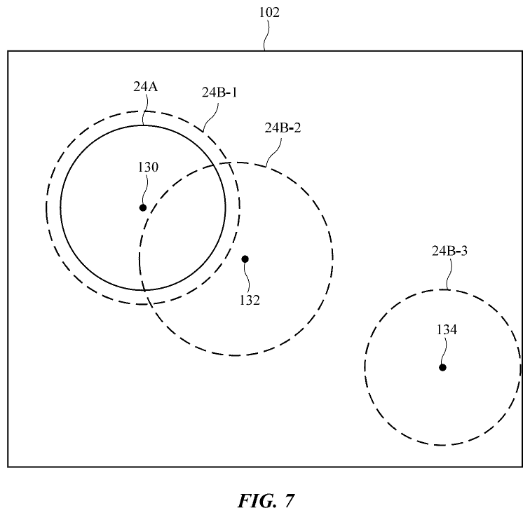

FIG. 7 is shows one example of how control circuitry 31 may compare network alert region 20A to carrier alert region 20B (e.g., while processing operation 78 of FIG. 3 and the operations of FIG. 6). As shown in FIG. 3, network alert region 20A may be bounded by a geofence 24A centered at location 130. Carrier alert region 20B may be bounded by a geofence 24B. When carrier alert region 20B has a similar radius and is located around a similar point (e.g., location 130) as network alert region 20A, such as when carrier alert region 20B is bound by geofence 24B-1, control circuitry 31 will output a similarity score e that is relatively close to 1.0. The more similar the radiuses and the more the two regions overlap each other, the higher the similarity score e and thus the more likely control circuitry 31 is to determine that the carrier and network alert regions are sufficiently similar to each other.

On the other hand, when carrier alert region 20B is centered around location 132 relatively far from location 130, such as when bound by geofence 24B-2, similarity score e will be much lower and control circuitry 31 is likely to determine that the carrier and network alert regions are insufficiently similar. Further, when carrier alert region 20B and network alert region 20A are completely non-overlapping (e.g., when carrier alert region 20B is centered at location 134 and bound by geofence 24B-3), similarity score e will be zero and control circuitry 31 will determine that the carrier and network alert regions are insufficiently similar. The example of FIG. 7 is illustrative and non-limiting. Network alert region 20A and carrier alert region 20B may have any desired shapes and/or sizes.

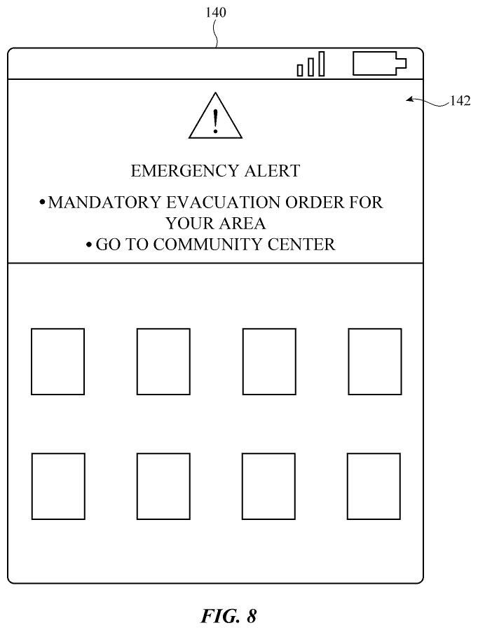

FIG. 8 shows an example of a graphical user interface that displays an emergency alert message (e.g., while processing step 84 of FIG. 3). As shown in FIG. 8, a graphical user interface (GUI) such as graphical user interface 140 may be displayed on the display of UE device 10 (e.g., by software such as an operating system of UE device 10).

When control circuitry 31 determines that UE device 10 is located within expanded alert region 20E and that the corresponding network alert region 20A is sufficiently similar to the corresponding carrier alert region 20B for a given emergency alert message 28, GUI 140 may display emergency alert 142 (e.g., at operation 84 of FIG. 3). Emergency alert 142 may be a graphical alert or notification that includes one or more graphical elements (e.g., icons, banners, badges, pop-up windows, etc.) and/or strings of text (e.g., the message body of emergency alert message 28, additional information from emergency alert message 28 such as supplemental instructions or location information, etc.). Emergency alert 142 may inform the user of UE device 10 about the emergency situation identified by emergency alert message 28. The example of FIG. 8 is illustrative and non-limiting. Any desired visual and/or non-visual indicators may be used to help inform the user of the emergency situation.

By processing emergency alert message 28 as described herein, UE device 10 may ensure that its user is notified of any relevant emergency situation as broadcast by emergency alert originator 18 regardless of what cellular network 22 the UE device is registered to, the emergency alert policies of the cellular network, and how the cellular network distorts or overshoots the nominal alert area in transmitting carrier alert message 28B. UE device 10 may also ensure that its user is notified even when UE device 10 is located nearby but not within the carrier alert region while still complying with carrier agreements. Further, UE device 10 may minimize the amount of time that passes between first transmission of emergency alert message 28 by emergency alert originator 18 and display of the emergency message at UE device 10. In sum, UE device 10 and core network 14 may maximize the safety of the users UE devices 10 across a wide range of geographic areas and cellular networks.

As used herein, the term “concurrent” means at least partially overlapping in time. In other words, first and second events are referred to herein as being “concurrent” with each other if at least some of the first event occurs at the same time as at least some of the second event (e.g., if at least some of the first event occurs during, while, or when at least some of the second event occurs). First and second events can be concurrent if the first and second events are simultaneous (e.g., if the entire duration of the first event overlaps the entire duration of the second event in time) but can also be concurrent if the first and second events are non-simultaneous (e.g., if the first event starts before or after the start of the second event, if the first event ends before or after the end of the second event, or if the first and second events are partially non-overlapping in time). As used herein, the term “while” is synonymous with “concurrent.”

As described above, one aspect of the present technology is the gathering and use of information such as user input, application data, and/or sensor information. The present disclosure contemplates that in some instances, this gathered data may include personal information data that uniquely identifies or can be used to contact or locate a specific person. Such personal information data can include demographic data, location-based data, telephone numbers, email addresses, twitter ID's, home addresses, data or records relating to a user's health or level of fitness (e.g., vital signs measurements, medication information, exercise information), date of birth, eyeglasses prescription, username, password, biometric information, or any other identifying or personal information.

The present disclosure recognizes that the use of such personal information, in the present technology, can be used to the benefit of users. For example, the personal information data can be used to deliver targeted content that is of greater interest to the user. Accordingly, use of such personal information data enables users to calculated control of the delivered content. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the United States, collection of or access to certain health data may be governed by federal and/or state laws, such as the Health Insurance Portability and Accountability Act (HIPAA), whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, the present technology can be configured to allow users to select to “opt in” or “opt out” of participation in the collection of personal information data during registration for services or anytime thereafter. In another example, users can select not to provide certain types of user data. In yet another example, users can select to limit the length of time user-specific data is maintained. In addition to providing “opt in” and “opt out” options, the present disclosure contemplates providing notifications relating to the access or use of personal information. For instance, a user may be notified upon downloading an application (“app”) that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data at a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data.

For one or more aspects, at least one of the components set forth in one or more of the preceding figures may be configured to perform one or more operations, techniques, processes, or methods as set forth herein. For example, the control circuitry as described above in connection with one or more of the preceding figures may be configured to operate in accordance with one or more of the examples set forth herein. For another example, circuitry associated with a UE, satellite, gateway, core network, base station, network element, etc. as described above in connection with one or more of the preceding figures may be configured to operate in accordance with one or more of the examples set forth herein.

An apparatus (e.g., an electronic user equipment device, a wireless base station, etc.) may be provided that includes means to perform one or more elements of a method described in or related to any of the methods or processes described herein.

One or more non-transitory computer-readable media comprising instructions to cause an electronic device, upon execution of the instructions by one or more processors of the electronic device, to perform one or more elements of any method or process described herein.

An apparatus comprising logic, modules, or circuitry to perform one or more elements of a method described in or related to any of the method or process described herein.

An apparatus comprising: one or more processors and one or more non-transitory computer-readable storage media comprising instructions that, when executed by the one or more processors, cause the one or more processors to perform the method, techniques, or process as described herein.

A signal, datagram, information element, packet, frame, segment, PDU, or message or datagram may be provided as described in or related to any of the examples described herein.

A signal encoded with data, a datagram, IE, packet, frame, segment, PDU, or message may be provided as described in or related to any of the examples described herein.

An electromagnetic signal may be provided carrying computer-readable instructions, wherein execution of the computer-readable instructions by one or more processors is to cause the one or more processors to perform the method, techniques, or process as described in or related to any of the examples described herein.

A computer program comprising instructions, wherein execution of the program by a processing element is to cause the processing element to carry out the method, techniques, or process as described in or related to any of the examples described herein.

A signal in a wireless network as shown and described herein may be provided.

A method of communicating in a wireless network as shown and described herein may be provided.

A system for providing wireless communication as shown and described herein may be provided.

A device for providing wireless communication as shown and described herein may be provided.

Any of the above-described examples may be combined with any other example (or combination of examples), unless explicitly stated otherwise. The foregoing description of one or more implementations provides illustration and description but is not intended to be exhaustive or to limit the scope of aspects to the precise form disclosed.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The foregoing is merely illustrative and various modifications can be made to the described embodiments. The foregoing embodiments may be implemented individually or in any combination.

What is claimed is:

1. A method of operating an electronic device, the method comprising:
receiving, using a receiver, a message from a core network, the message identifying a first geographic region associated with an emergency alert broadcast by an emergency alert originator; and
displaying, using a display, a message body of the emergency alert when the electronic device is located in a second geographic region, the second geographic region being larger than the first geographic region and including the first geographic region.

2. The method of claim 1, wherein the message identifies the first geographic region by a set of vertices.

3. The method of claim 2, wherein the second geographic region comprises a hull that encloses a set of polygons, each polygon in the set of polygons surrounding a respective vertex in the set of vertices.

4. The method of claim 3, wherein each polygon in the set of polygons has an augmented radius.

5. The method of claim 4, wherein the augmented radius is based on an expiration time of the emergency alert.

6. The method of claim 4, wherein the augmented radius is based on a severity level of the emergency alert.

7. The method of claim 4, wherein the augmented radius is based on an area of the first geographic region.

8. The method of claim 4, wherein the augmented radius is based on a speed of the electronic device.

9. The method of claim 4, further comprising:
generating, using one or more processors, the augmented radius based on a Scaled Sigmoid Transition; and
adjusting, using the one or more processors, the augmented radius over time by adjusting one or more constants of the Scaled Sigmoid Transition.

10. The method of claim 1, further comprising:
discarding, using one or more processors, the message when the electronic device is located outside the second region.

11. The method of claim 1, wherein the message comprises a hypertext transfer protocol (HTTP) message.

12. The method of claim 10, further comprising:
receiving, using one or more antennas, an additional message from a cellular network different from the core network, wherein the additional message identifies a third geographic region associated with the emergency alert and displaying the message body includes displaying the message body after receipt of the additional message.

13. The method of claim 11, wherein displaying the message body further includes displaying the message body when a similarity score between the first geographic region and the third geographic region exceeds a threshold value, the method further comprising:
discarding, using one or more processors, the message when the similarity score is less than the threshold value.

14. A method of operating an electronic device, the method comprising:
receiving, using a receiver, a first message from a core network, the first message identifying a first geographic region associated with an emergency alert broadcast by an emergency alert originator;
receiving, using one or more antennas, a second message from a cellular network different from the core network, the second message identifying a second geographic region associated with the emergency alert; and
displaying, using a display, a message body of the emergency alert when the first geographic region and the second geographic region exhibit more than a threshold level of similarity.

15. The method of claim 14, wherein the first message identifies the first geographic region by a first set of vertices, the second message identifies the second geographic region by a second set of vertices, and displaying the message body comprises displaying the message body when each vertex in the second set of vertices is less than a threshold distance from at least one vertex in the first set of vertices.

16. The method of claim 14, wherein the first geographic region has a first area, the second geographic region has a second area, and displaying the message body comprises displaying the message body when an area of overlap between the first geographic region and the second geographic region, divided by a larger of the first area or the second area, exceeds a threshold value.

17. The method of claim 14, wherein the first message comprises a hypertext transfer protocol (HTTP) message.

18. An electronic device comprising:
a receiver configured to receive, from a core network, a first message identifying a first geographic area associated with an emergency alert broadcast by an emergency alert originator;
one or more antennas configured to receive, from a cellular network different from the core network, a second message identifying a second geographic area associated with the emergency alert; and
a display configured to display, based on the geographic area, a location of the electronic device, and a velocity of the electronic device, a message body of the emergency alert after receipt of the second message by the one or more antennas.

19. The electronic device of claim 18, further comprising:
one or more processors configured to generate, prior to receipt of the second message by the one or more antennas, an expanded geographic area based on the first geographic area and the velocity of the electronic device, the display being configured to display the message body when the electronic device is located in the expanded geographic area.

20. The electronic device of claim 19, the one or more processors being further configured to generate the expanded geographic area based on a size of the first geographic area, an expiration time of the emergency alert as identified by the first message, and a severity level of the emergency alert as identified by the first message.
